(19) United States
(12) Patent Application Publication
(10) Pub. No.: US 2017/0122441 A1
(43) Pub. Date: May 4, 2017

(54) Reduced Stress Ball Seat

(71) Applicant: Baker Hughes Incorporated, Houston, TX (US)

(72) Inventor: Mark Kendall Adam, Houston, TX (US)

(73) Assignee: Baker Hughes Incorporated, Houston, TX (US)

(21) Appl. No.: 14/926,504

(22) Filed: Oct. 29, 2015

(51) Int. Cl. F16K 1/42; E21B 34/10; F16K 1/14

(52) U.S. Cl. CPC F16K 1/42; F16K 1/14; E21B 34/10; E21B 2034/007

(57) ABSTRACT

A releasable ball seat with a capturing sleeve having a restricted diameter portion and an enlarged lower end opening. The restricted diameter portion is separated from the enlarged lower end opening to ensure that hoop stresses are not imposed upon the lower end opening.

### BACKGROUND OF THE INVENTION

1. Field of the Invention

The invention relates generally to the design of ball seats of the type used in downhole operations.

2. Description of the Related Art

Ball seats are fluid flow restrictions within a section of tubing that are used to land balls or plugs of other shapes at a selected location within a tools or section of tubing within a wellbore. In the claims and description, the term “ball” will be used to refer broadly to spherical balls as well as non-spherical plugs, darts and members having other shapes which are flowed through the flowbore of a section of tubing to be landed on a seat, thereby blocking or partially blocking the flowbore. Balls and ball seats are useful because they allow fluid pressure to be built up behind the ball, after landing, to shift a sliding sleeve or perform another function.

Pump-through or flow-through ball seats, also known as releasable ball seats, are used in instances wherein it is desired to be able to land a ball onto a ball seat and, after a sleeve is shifted or another function performed, subsequently release the ball from the ball seat so that fluid can once more flow through the flowbore. Many conventional ball seat designs have the restricted diameter portion at the lowest end of the capturing seat. The inventor has determined that this design can be prone to failure as the lower end of the seat can split as a ball is passed through.

### SUMMARY OF THE INVENTION

The invention provides improved releasable ball seat designs. Exemplary ball seats are described which feature a ball seat body that is preferably formed of deformable metal or similar material which will plastically deform when a ball or plug is passed through. A first exemplary releasable ball seat is described which has a first enlarged opening end, a second enlarged opening end and a reduced diameter central portion. The ball seat can pass a variety of different sized balls. Because the restricted diameter portion of the ball seat, which must deform in order to pass a ball, is not located at an axial end/edge of the ball seat, the potential for the ball seat to fail due to splitting is greatly reduced. Releasable ball seats in accordance with the present invention can be used in a variety of tools, including surge control valves and liner hanger running tools.

### BRIEF DESCRIPTION OF THE DRAWINGS

For a thorough understanding of the present invention, reference is made to the following detailed description of the preferred embodiments, taken in conjunction with the accompanying drawings, wherein like reference numerals designate like or similar elements throughout the several figures of the drawings and wherein:

FIG. 1 is a side, cross-sectional view of an exemplary wellbore containing production tubing and a sliding sleeve valve which has a releasable ball seat constructed in accordance with the present invention.

FIG. 2 is a side, cross-sectional view of an exemplary extrudable ball seat sub which includes a ball seat constructed in accordance with the present invention.

FIG. 3 is a side, cross-sectional view of an exemplary ball seat constructed in accordance with the present invention and having a first ball landed upon the ball seat.

FIG. 4 is a side, cross-sectional view of the ball seat shown in FIG. 1, now with the first ball having been passed through.

FIG. 5 is a side, cross-sectional view of the ball seat shown in FIGS. 1-2, now with a second ball having been landed on the seat and being passed through.

FIG. 6 is a side, cross-sectional view of the ball seat shown in FIGS. 1-3 now with a third ball having been landed on the seat and being passed through.

### DETAILED DESCRIPTION OF THE PREFERRED EMBODIMENTS

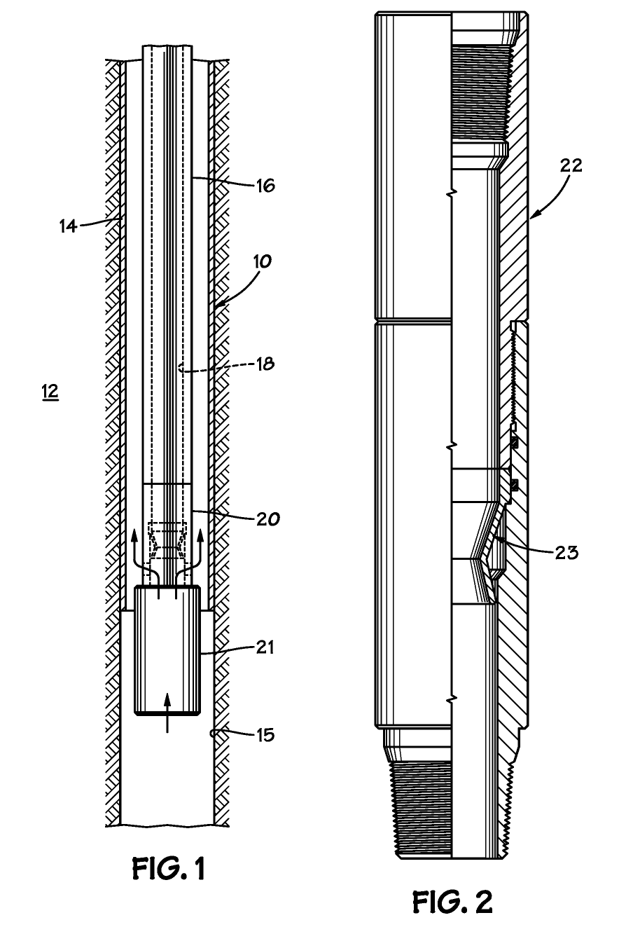

FIG. 1 depicts an exemplary wellbore 10 which has been drilled through the earth 12 and which is partially lined with a metallic casing 14 and having an unlined portion 15 below. A work string 16 is disposed within the wellbore 10, the work string 16 defining an interior flowbore 18 along its length. A sliding sleeve mechanism 20 is incorporated into the tubing string. In accordance with preferred embodiments, the sliding sleeve mechanism 20 is a surge control valve, such as the Baker Hughes Hyflo valve. In other embodiments, the sliding sleeve mechanism 20 might comprise a circulation tool of the type described in U.S. Pat. No. 8,356,671 by Guillory et al. According to preferred embodiments, the sliding sleeve mechanism 20 is adapted to capture and release balls of different sizes during operation. Below the sliding sleeve mechanism 20 is a larger sizes tubular 21 being installed in the wellbore 10. Those of skill in the art will be familiar with the techniques needed to place a ball seat within a sliding sleeve mechanism. One or more balls can be dropped from surface through the flowbore 18 of the work string 16 in order to operate the sliding sleeve mechanism 20 as the one or more balls are captured and released from a ball seat within the sliding sleeve mechanism 20.

Additionally, FIG. 2 illustrates an exemplary extrudable ball seat sub 22 which contains a ball seat 23 which is constructed in accordance with the present invention. With this tool, a ball (not shown) is landed upon the ball seat 23 to allow fluid pressure to be built up above the ball seat sub 22 to hydraulically actuate tools in the work string above the ball seat sub 22. After all tools have been actuated, additional pressure is applied to extrude the ball through the ball seat 23.

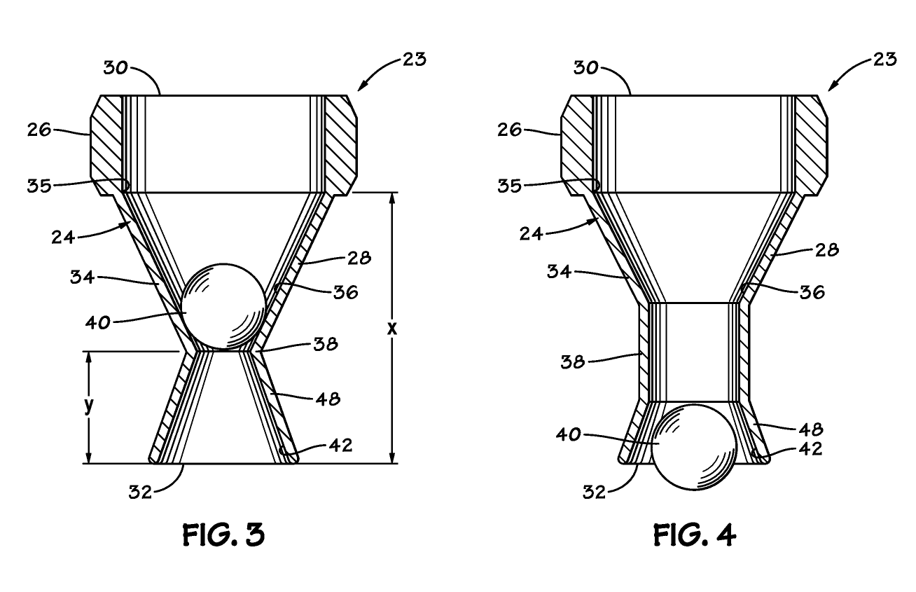

FIGS. 3-6 depict an exemplary ball seat 23 apart from other components of the sliding sleeve mechanism 20. The ball seat 23 is preferably formed of metal, such as steel, that is capable of a high percentage of plastic deformation. In the depicted embodiment, the ball seat 23 has a generally cylindrical ball seat body 24 having an enlarged diameter entry ring 26. A capturing sleeve 28 extends downwardly below the entry ring 26. In accordance with preferred embodiments, the entry ring 26 is sized to permit the passage there through of actuating balls of any anticipated size for operation of the sliding sleeve device. The entry ring 26 may also be used to fix and seal the ball seat body 24 within a tool in which it is installed. The capturing sleeve 28 of the ball seat 23 is adapted to capture and release various sized balls in order to operate the sliding sleeve mechanism 20. The ball seat body 24 has an axial upper end 30 and an axial lower end 32.

The capturing sleeve 28 has a design that reduces the chance of ball seat failure. In particular, the capturing sleeve 28 presents a tapered upper portion 34 extending downwardly from ball opening 35. The radial interior of the tapered upper portion 34 provides a ball seating surface 36. The capturing sleeve 28 also includes a restricted diameter central portion 38 at the lower end of the tapered upper portion 34. The restricted diameter central portion 38 is the portion of the capturing sleeve 28 which has the smallest diameter. As illustrated by FIG. 3, the restricted diameter central portion 38 is small enough initially to capture the smallest of balls which might be used to operate the sliding sleeve mechanism 20. FIG. 3 illustrates a small actuation ball 40 which is seated upon the seating surface 36 and prevented from passing through the ball seat 23 by the restricted diameter central portion 38. Below the restricted diameter central portion 38, the capturing sleeve 28 widens out to an enlarged diameter lower opening 42 which is at the lower axial end 32. The enlarged diameter lower opening 42 has a larger diameter than the restricted diameter central portion 38 as well as a diameter larger than or nearly as large as any of the balls 40, 44, 46 which will be captured and released by the ball seat 23. Preferably, the enlarged diameter lower opening 42 is not subjected to significant hoop stress as balls pass through the capturing sleeve 28. Also, it is preferred that the capturing sleeve 28 taper radially outwardly from the restricted diameter central portion 38 to the enlarged diameter lower opening 42, as illustrated by the flared portion 48 in FIGS. 3-6.

The capturing sleeve 28 is intended to plastically deform, without rupturing, as balls are passed through the ball seat 23. By plastically deforming, the capturing sleeve 28 will be permanently enlarged without elastically returning to its original shape. The material of the capturing sleeve 28 is sufficiently rigid to allow a ball to be captured upon a seating surface therein but plastically deformable to release the ball in response to an overpressure. Therefore, wall thickness of the capturing sleeve 28 and the taper angle of the tapered upper portion 34 should be adjusted based upon the anticipated ball size and desired overpressure required for deformation to ensure that this occurs.

Operation of the ball seat 23 to capture and release different sized balls is illustrated by FIGS. 3-6. In FIG. 3, small ball 40 has been landed upon the seating surface 36. Typically, fluid pressure is then built up behind the small ball 40 to urge a sliding sleeve within the sliding sleeve mechanism 20 to shift or to allow other tools to be hydraulically actuated, as noted above. When it is desired to pump or extrude the small ball 40 through the ball seat 23, overpressure within the work string 16 will urge the small ball 40 against the capturing sleeve 28 and radially enlarge the restricted diameter central portion 38, as illustrated in FIG. 4. It is noted that this deformation is plastic rather than elastic. It is also noted that hoop stress during deformation is located away from the lower end opening 42, therefore, reducing the possibility that the capturing sleeve 28 might split at that point. In accordance with particular embodiments, the restricted diameter central portion 38 is located at least one third of the distance of the axial distance between the lower axial end 32 and the ball opening 35. As illustrated by FIG. 3, the ball opening 35 and the lower axial end 32 are separated by a first distance (“x”) while the restricted diameter central portion 38 and lower axial end 32 are separated by a second distance (“y”). In accordance with preferred embodiments, the distance y is from ⅛ to ⅞ of distance x. In accordance with particularly preferred embodiments, the distance y is from ¼ to ½ of x. In accordance with further particularly preferred embodiments, the distance y is about ⅓ of x. As a result, hoop stresses are not imposed upon the lower end opening 42 when balls 40, 44 or 46 are passed through.

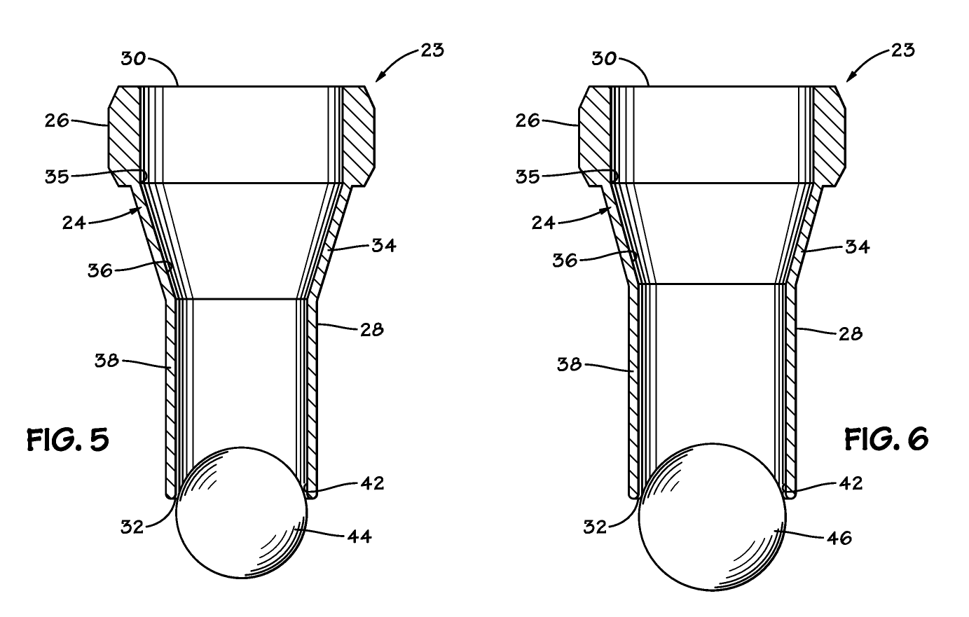

FIGS. 5 and 6 illustrate the subsequent extrusion or release of medium sized ball 44 and large sized ball 46. As FIGS. 5 and 6 illustrate, the capturing sleeve 28 plastically deforms radially outwardly in order to accommodate extrusion of each ball 44 and 46.

Those of skill in the art will recognize that numerous modifications and changes may be made to the exemplary designs and embodiments described herein and that the invention is limited only by the claims that follow and any equivalents thereof.

What is claimed is:

1. A releasable ball seat for use in a tool within a wellbore to capture and release a ball, the ball seat comprising:
a capturing sleeve formed of a material that is sufficiently rigid to allow a ball to be captured upon a seating surface therein but plastically deformable to release the ball in response to an overpressure, the capturing sleeve having:
an upper portion having a ball opening and which presents a seating surface upon which a ball will rest when captured and a lower end;
a restricted diameter central portion at the lower end of the tapered upper portion; and
a flared portion below the restricted diameter central portion, the flared portion extending between the restricted diameter portion and an enlarged diameter lower opening.

2. The releasable ball seat of claim 1 further comprising an enlarged diameter entry ring from which the capturing sleeve depends downwardly.

3. The releasable ball seat of claim 1 wherein the ball seat is formed of metal.

4. The releasable ball seat of claim 3 wherein the metal is steel.

5. The releasable ball seat of claim 1 wherein:
the ball opening and the enlarged diameter lower opening are separated by a first distance;
the enlarged diameter lower opening and the restricted diameter central portion are separated at a second distance from each other; and
the second distance is from ⅛ to ⅞ of the first distance.

6. The releasable ball seat of claim 5 wherein the second distance is from % to ½ of the first distance.

7. The releasable ball seat of claim 5 wherein the second distance is about ⅓ of the first distance.

8. A releasable ball seat for use in a tool within a wellbore to capture and release a ball, the ball seat comprising:
an enlarged diameter entry ring;
a capturing sleeve extending downwardly from the entry ring and being formed of a material that is sufficiently rigid to allow a ball to be captured upon a seating surface therein but plastically deformable to release the ball in response to an overpressure, the capturing sleeve having:
a tapered upper portion having a ball opening and which presents a seating surface upon which a ball will rest when captured and a lower end;
a restricted diameter central portion at the lower end of the tapered upper portion; and
a flared portion below the restricted diameter central portion, the flared portion extending between the restricted diameter portion and an enlarged diameter lower opening.

9. The releasable ball seat of claim 8 wherein the ball seat is formed of metal.

10. The releasable ball seat of claim 9 wherein the metal is steel.

11. The releasable ball seat of claim 8 wherein:
the ball opening and the enlarged diameter lower opening are separated by a first distance;
the enlarged diameter lower opening and the restricted diameter central portion are separated at a second distance from each other; and
the second distance is ⅛ to ⅞ of the first distance.

12. The releasable ball seat of claim 11 wherein the second distance is from ¼ to ½ of the first distance.

13. The releasable ball seat of claim 11 wherein the second distance is about ⅓ of the first distance.

14. A releasable ball seat for use in a tool within a wellbore to capture and release a ball, the ball seat comprising:
an enlarged diameter entry ring;
a capturing sleeve formed of metal and extending downwardly from the entry ring and being formed of a material that is sufficiently rigid to allow a ball to be captured upon a seating surface therein but plastically deformable to release the ball in response to an overpressure, the capturing sleeve having:
a tapered upper portion having a ball opening and which presents a seating surface upon which a ball will rest when captured and a lower end;
a restricted diameter central portion at the lower end of the tapered upper portion; and
a flared portion below the restricted diameter central portion, the flared portion extending between the restricted diameter portion and an enlarged diameter lower opening.

15. The releasable ball seat of claim 14 wherein:
the ball opening and the enlarged diameter lower opening are separated by a first distance;
the enlarged diameter lower opening and the restricted diameter central portion are separated at a second distance from each other; and
the second distance is from ⅛ to ⅞ of the first distance.

16. The releasable ball seat of claim 15 wherein the second distance is from ¼ to ½ of the first distance.

17. The releasable ball seat of claim 15 wherein the second distance is about ⅓ of the first distance.
